(19) United States
(12) Patent Application Publication
(10) Pub. No.: US 2008/0180845 A1
(43) Pub. Date: Jul. 31, 2008

(54) Slider air bearing for disk drives

(76) Inventors: Albert Wallash, Morgan Hill, CA (US); Hong Zhu, Mountain View, CA (US)

Correspondence Address: HITACHI C/O WAGNER BLECHER LLP, 123 WESTRIDGE DRIVE, WATSONVILLE, CA, 95076, US

(21) Appl. No.: 11/701,091

(22) Filed: Jan. 31, 2007

(51) Int. Cl. G11B 5/60

(52) U.S. Cl. 360/234.3

(57) ABSTRACT

A head slider for a magnetic disk drive is provided. The head slider includes a leading edge, a trailing edge and a ramp structure for deflecting impact of the slider with a disk defect, the ramp structure comprising a leading end and a trailing end wherein the ramp structure is higher with respect to the air bearing surface at the trailing end than the leading end and wherein the trailing end of the ramp structure is proximate the trailing end of the slider.

### TECHNICAL FIELD

The field of the present invention relates to disk drive data storage devices. More particularly, embodiments of the present invention are related to head degradation of a disk drive slider due to disk defects.

### BACKGROUND ART

Direct access storage devices (DASD) have become part of everyday life, and as such, expectations and demands continually increase for greater speed for manipulating and for holding larger amounts of data. To meet these demands for increased performance, the mechano-electrical assembly in a DASD device, specifically the Hard Disk Drive (HDD) has evolved to meet these demands.

Advances in magnetic recording heads as well as the disk media have allowed more data to be stored on a disk's recording surface. The ability of an HDD to access this data quickly is largely a function of the performance of the mechanical components of the HDD. Once this data is accessed, the ability of an HDD to read and write this data quickly is a primarily a function of the electrical components of the HDD.

A computer storage system may include a magnetic hard disk(s) or drive(s) within an outer housing or base containing a spindle motor assembly having a central drive hub that rotates the disk. An actuator includes a plurality of parallel actuator arms in the form of a comb that is movably or pivotally mounted to the base about a pivot assembly. A controller is also mounted to the base for selectively moving the comb of arms relative to the disk.

Each actuator arm has extending from it at least one cantilevered electrical lead suspension. A magnetic read/write transducer or head is mounted on a slider and secured to a flexure that is flexibly mounted to each suspension. The read/write heads magnetically read data from and/or magnetically write data to the disk. The level of integration called the head gimbal assembly (HGA) is the head and the slider, which are mounted on the suspension. The slider is usually bonded to the end of the suspension.

A suspension has a spring-like quality, which biases or presses the air-bearing surface of the slider against the disk to cause the slider to fly at a precise distance from the disk. Movement of the actuator by the controller causes the head gimbal assemblies to move along radial arcs across tracks on the disk until the heads settle on their set target tracks. The head gimbal assemblies operate in and move in unison with one another or use multiple independent actuators wherein the arms can move independently of one another.

### SUMMARY OF THE INVENTION

Embodiments of the present invention include a head slider for a magnetic disk drive. In one embodiment of the invention, the head slider includes a leading edge, a trailing edge and a ramp structure for deflecting impact of the slider with a disk defect, the ramp structure comprising a leading end and a trailing end wherein the ramp structure is higher with respect to the air bearing surface at the trailing end than the leading end and wherein the trailing end of the ramp structure is proximate the trailing end of the slider.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic, top plan view of a hard disk drive in accordance with one embodiment of the present invention.

FIG. 2 is a side view of an exemplary disk drive slider including a read sensor protector in accordance with embodiments of the present invention.

FIG. 3 is a side view of an exemplary disk drive slider and an exemplary disk surface including a disk defect in accordance with embodiments of the present invention.

FIG. 4 is an air bearing surface view of an exemplary disk drive slider in accordance with embodiments of the present invention.

### DETAILED DESCRIPTION

Reference will now be made in detail to the alternative embodiment(s) of the present invention, a slider air bearing for hard disk drives. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

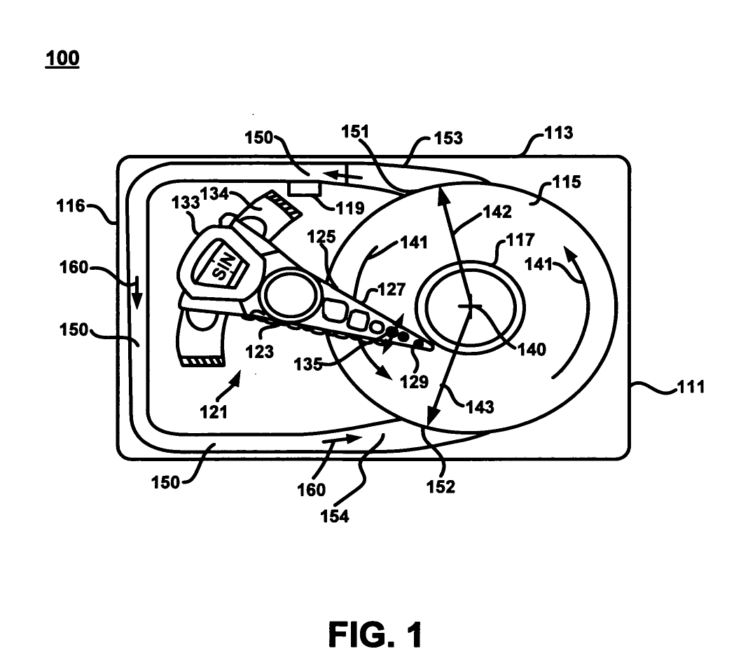

With reference now to FIG. 1, a schematic drawing of one embodiment of an information storage system 100 comprising a magnetic hard disk file or drive 111 for a computer system is shown. Drive 111 has an outer housing or base 113 containing a disk pack having at least one media or magnetic disk 115. The disk or disks 115 are rotated (see arrows 141) by a spindle motor assembly having a central drive hub 117. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered load beam and suspension 127. A magnetic read/write transducer or head is mounted on a slider 129 and secured to a flexure that is flexibly mounted to each suspension 127. The read/write heads magnetically read data from and/or magnetically write data to disk 115. The level of integration called the head gimbal assembly (HGA) is head and the slider 129, which are mounted on suspension 127. The slider 129 is usually bonded to the end of suspension 127. The head is typically pico size (approximately 1160×1000×300 microns) and formed from ceramic or intermetallic materials. The head also may be of “femto” size (approximately 850×700×230 microns) and is pre-loaded against the surface of disk 115 (in the range two to ten grams) by suspension 127.

Suspensions 127 have a spring-like quality, which biases or urges the air-bearing surface of the slider 129 against the disk 115 to cause the slider 129 to fly at a precise distance from the disk. A voice coil 133 free to move within a conventional voice coil motor magnet assembly 134 (top pole not shown) is also mounted to arms 125 opposite the head gimbal assemblies. Movement of the actuator 121 (indicated by arrow 135) by controller 119 moves the head gimbal assemblies along radial arcs across tracks on the disk 115 until the heads settle on their respective target tracks. The head gimbal assemblies operate in a conventional manner and always move in unison with one another, unless drive 111 uses multiple independent actuators (not shown) wherein the arms can move independently of one another.

Referring still to FIG. 1, the disk pack and disks 115 (one shown) define an axis 140 of rotation 141 and radial directions 142, 143, relative to the axis 140. The drive 111 also has a bypass channel 150 formed in the housing 113 for directing the airflow 160 generated by rotation of the disks 115 from the upstream side of the disk pack or disks (e.g., proximate to radial direction 142 in FIG. 1) 115 to the downstream side of the disk pack or disks 115 (e.g., proximate to radial direction 143 in FIG. 1).

In the embodiment shown, the bypass channel 150 is located between an outer perimeter 116 of the housing 113 and the actuator 121, such that the bypass channel 150 completely circumscribes the actuator 121. Bypass channel 150 further comprises a first opening 151 proximate to upstream side wherein air is conveyed away from the disks 115 and a second opening 152 proximate to downstream side wherein airflow 160 is directed toward the disks 115.

As shown in FIG. 1, one embodiment of the drive 111 bypass channel 150 constructed in accordance with the present invention also comprises a diffuser 153. In the embodiment shown, the diffuser 153 is located in the bypass channel 150 and is positioned adjacent to the upstream side of the disk pack or disks 115. The diffuser 153 is also offset upstream from the disks 115 in the radial direction 142, such that the diffuser 153 reduces airflow drag from the disks 115 due to disk wake in the bypass channel 150. This type of aerodynamic drag is commonly called base drag.

Alternatively, or operating in conjunction with the diffuser 153, another embodiment of the drive 111 may include a contraction 154 (e.g., a Venturi). The contraction 154 is also located in the bypass channel 150, but is adjacent to the downstream side of the disk pack or disks 115. Like the diffuser 153, the contraction 154 is typically offset downstream from the disks 115, but in a radial direction 143. Each of the diffuser 153 and the contraction 154 may be spaced apart from the outer edges of the disks 115 in radial directions 142, 143 by, for example, approximately 0.5 mm. The contraction 154 may be provided for re-accelerating bypass airflow 160 to provide efficient energy conversion for the air flow from pressure energy to kinetic energy prior to merging bypass airflow 160 with air flow 141 around the disks 115.

The use of bypass channel 150 has several advantages, including the ability to reduce aerodynamic buffeting of actuator 121 during the servo writing process and/or during normal operation of disk drive system 111. More specifically, bypass channel 150 reduces the pressure build-up on the upstream side of actuator 121 which occurs when drive 111 is operated. Additionally, directing airflow 160 around the actuator 121 decreases the upstream pressure on the actuator, thus reducing force acting on the actuator 121 while reducing the energy of the bluff-body wake of the actuator arm.

In embodiments of the present invention, disk drive system 111 may be filled with a gas (e.g., helium) rather than ambient air. This may be advantageous in that helium is a lighter gas than ambient air and causes less buffeting of actuator 121 when disk drive system 111 is in operation. In embodiments of the present invention, disk drive 111 may be sealed after the servo writing process to keep the helium in the drive. Alternatively, the helium may be removed from disk drive 111 and ambient air is allowed to return into the disk drive prior to sealing first opening 151 and second opening 152.

### Disk Drive Head Slider for Deflecting Impact with A Disk Defect

Disk drive heads can degrade from collision with disk defects. Embodiments of the present invention include a head slider for reducing the physical damage to head sensors from contact with disk defects. Specifically, embodiments of the present invention include a head slider design that uses a ramp structure to deflect impact of the head slider with a disk defect away from a head slider read sensor. In one embodiment of the invention, the ramp structure is designed to protect the read sensor from a direct hit with a disk defect, thus improving read sensor reliability. In one embodiment of the invention, the ramp structure comprises a material that is harder than the disk defect (e.g., harder than alumina) so that the impact between the ramp structure and the disk defect actually self-heals disk defects by wearing them down.

In one embodiment of the invention, the head slider includes a barrier (e.g., a ramp structure) in front (e.g., upstream) of the read sensor in order to deflect the disk defect away from the sensor and shield the sensor from mechanical damage.

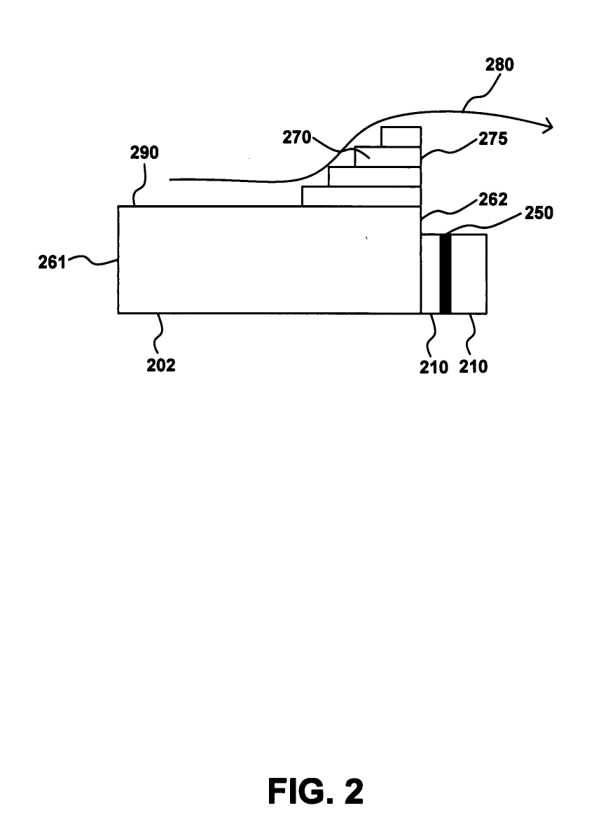

FIG. 2 is a side view of an exemplary disk drive slider 202 including a read sensor protector 270 in accordance with embodiments of the present invention. As stated above, the head slider 202 includes a ramp structure 270 for protecting the read sensor 250 from physical damage resulting from collision with a disk defect.

In one embodiment of the invention, the ramp structure is disposed closer to the trailing edge 262 of the slider 202 than the leading edge 261 of the slider. In one embodiment of the invention, the read head 250 is coupled to the head slider 202 proximate the trailing edge 262. In one embodiment of the invention, the read sensor 250 includes a shield 210.

In one embodiment of the invention, the ramp structure 270 deflects the trajectory 280 of an impact between the head slider and a disk defect. The ramp provides protection from direct impact between a disk defect and the read sensor 250. In one embodiment of the invention, the ramp structure 270 is highest at the trailing edge 260 and lowest closer towards the leading edge 261 with respect to the air bearing surface 290 of slider 202.

In one embodiment of the invention, the ramp structure 270 includes a plurality of layers 275. In one embodiment of the invention, any number of layers 270 can be formed one at a time on the surface of the air bearing 290 to build up the ramp structure 270. The layers 270 may include differing heights with respect to the air bearing and may also be of differing lengths to build the ramp structure 270. It is also appreciated that the ramp structure 270 can be a stand alone structure that can be bonded to the slider 202 in any number of ways in accordance with embodiments of the present invention.

It is appreciated that the height of the ramp structure, with respect to the air bearing surface 290 is less than the designed fly height of the slider 202. In one embodiment of the invention, the ramp structure is less than 3.5 nanometers in height with respect to the air bearing surface 290 of the slider 202.

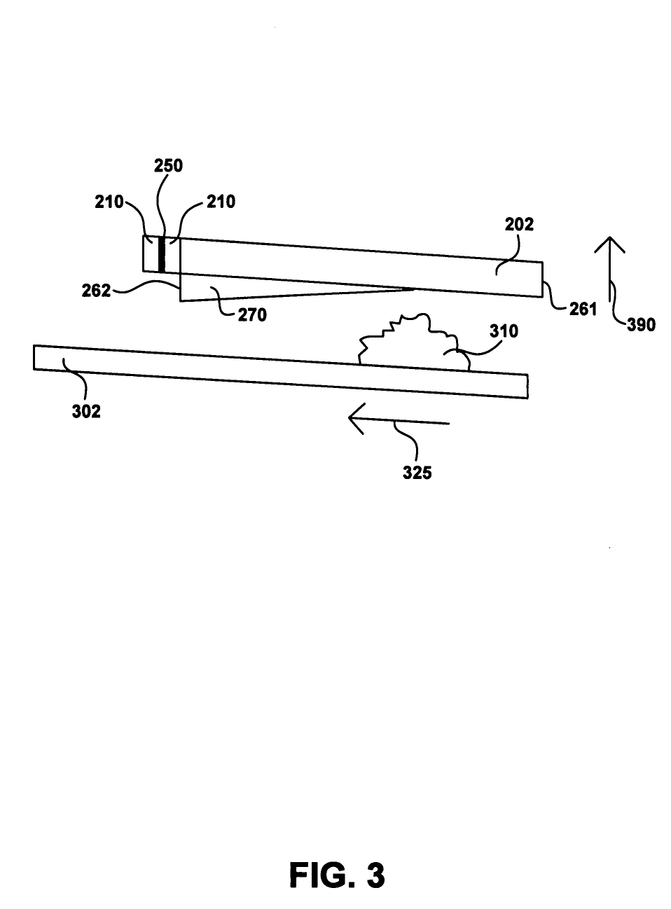

FIG. 3 is a side view of an exemplary disk drive slider 202 and an exemplary disk surface 302 including a disk defect 310 in accordance with embodiments of the present invention. As stated above, the ramp structure 270 deflects the trajectory (280 of FIG. 2) of impact between the head slider 202 and a disk defect 310. The disk 302 is rotating in direction 325 past the leading edge 261 and towards the trailing edge 262 of the head slider 202. The ramp structure 270 impacts the disk defect 310 to protect the read sensor 250. In one embodiment of the invention the ramp structure 270 rides over the disk defect 310 and causes the slider 202 to deflect in an upwards direction 390 with respect to the disk surface 302. By the time the head slider is returned to a normal fly height, the slider is past the disk defect 310.

As stated above, in the case the ramp structure 270 is harder than the disk defect 310, the ramp structure wears the defect 310 and actually self heals the disk defect 310 so that impacts are greatly reduced over time.

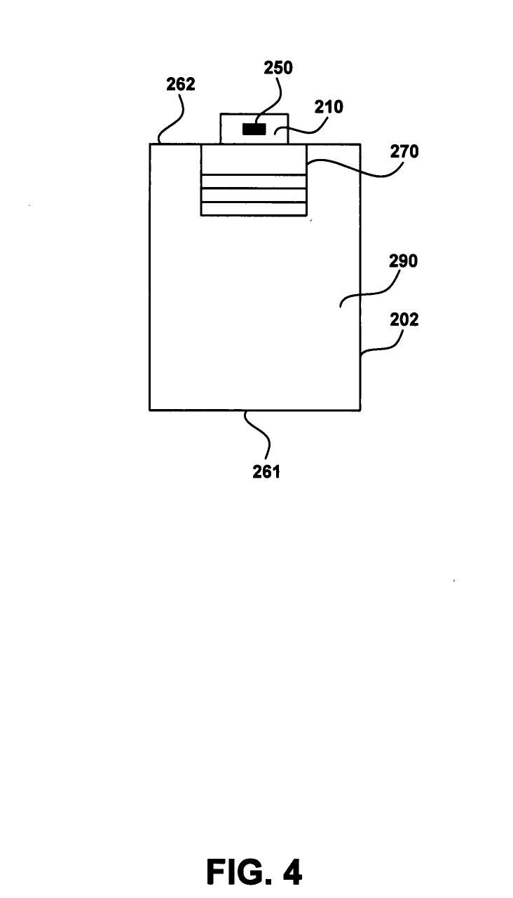

FIG. 4 is an air bearing surface view of an exemplary disk drive slider 202 in accordance with embodiments of the present invention. In one embodiment of the invention, the ramp structure 270 is centered with respect to the read sensor 250 on the air bearing surface 290 of the head slider 202. As stated above, the ramp structure is located proximate the trailing edge 262 of the head slider 202. The ramp structure 270 is near the air bearing surface 290 closer to the leading edge 261 of the slider 202 and approaches maximum height closer to the trailing edge 262. The ramp structure 270 is a protective barrier for the read sensor 250 to protect the read sensor 250 from direct impact with a disk defect.

The ramp 270 is designed so that the trajectory of the scratch along the air bearing 290 misses the read sensor 250, thus reducing head degradation resulting from direct impact with a disk defect.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A head slider for a magnetic disk drive, said slider comprising a leading edge and a trailing edge of an air bearing surface, said head slider further comprising:
a ramp structure for deflecting impact of said slider with a disk defect, said ramp structure comprising a leading end and a trailing end wherein said ramp structure is higher with respect to said air bearing surface at said trailing end than said leading end and wherein said trailing end of said ramp structure is proximate said trailing end of said slider.

2. The head slider as described in claim 1 wherein said ramp structure comprises a plurality of layers disposed on said air bearing surface.

3. The head slider as described in claim 1 wherein said ramp structure comprises material that is harder than said disk defect and wherein said ramp structure wears said disk defect as a result of said impact.

4. The head slider as described in claim 1 further comprising:
a read sensor and a write head coupled down stream from said trailing edge of said slider, said ramp structure deflecting said impact of said disk defect away from said head slider to protect said read sensor and said write head from said impact.

5. The head slider as described in claim 4 wherein said ramp structure is centered on said head with respect to said read sensor.

6. The head slider as described in claim 4 wherein said ramp structure reduces degradation of said read sensor resulting from said impact of said slider with a disk defect.

7. The head slider as described in claim 1 wherein a maximum height of said ramp structure with respect to said air bearing surface is less than a minimum fly height of said head with respect to a disk of said disk drive.

8. A disk drive assembly comprising:
a rotatable magnetic disk; and
a head gimbal assembly coupled to an actuator, said head gimbal assembly comprising a head slider, said slider comprising a leading edge and a trailing edge of an air bearing surface, said head slider further comprising:
a ramp structure for deflecting impact of said slider with a disk defect, said ramp structure comprising a leading end and a trailing end wherein said ramp structure is higher with respect to said air bearing surface at said trailing end than said leading end and wherein said trailing end of said ramp structure is proximate said trailing end of said slider.

9. The disk drive assembly as described in claim 8 wherein said ramp structure comprises a plurality of layers disposed on said air bearing surface.

10. The disk drive assembly as described in claim 8 wherein said ramp structure comprises material that is harder than said disk defect and wherein said ramp structure wears said disk defect as a result of said impact.

11. The disk drive assembly as described in claim 8 further comprising:
a read sensor coupled down stream from said trailing edge of said slider, said ramp structure deflecting said impact of said disk defect away from said head slider to protect said read sensor from said impact.

12. The disk drive assembly as described in claim 11 wherein said ramp structure is centered on said head with respect to said read sensor.

13. The disk drive assembly as described in claim 11 wherein said ramp structure reduces degradation of said read sensor resulting from said impact of said slider with a disk defect.

14. The disk drive assembly as described in claim 8 wherein a maximum height of said ramp structure with respect to said air bearing surface is less than a minimum fly height of said head with respect to said disk.

15. A head gimbal assembly comprising a head slider for reducing degradation of a read sensor coupled to said head slider resulting from impact of said head slider with a disk defect, said head slider comprising:
an air bearing surface comprising a leading edge and a trailing edge; and
a ramp structure for deflecting impact of said slider with a disk defect, said ramp structure comprising a leading end and a trailing end wherein said ramp structure is higher with respect to said air bearing surface at said trailing end than said leading end and wherein said trailing end of said ramp structure is proximate said trailing end of said slider.

16. The head gimbal assembly as described in claim 15 wherein said ramp structure comprises a plurality of layers disposed on said air bearing surface.

17. The head gimbal assembly as described in claim 15 wherein said ramp structure comprises material that is harder than said disk defect and wherein said ramp structure wears said disk defect as a result of said impact.

18. The head gimbal assembly as described in claim 15 further comprising:
a read sensor coupled down stream from said trailing edge of said slider, said ramp structure deflecting said impact of said disk defect away from said head slider to protect said read sensor from said impact.

19. The head gimbal assembly as described in claim 18 wherein said ramp structure is centered on said head with respect to said read sensor.

20. The head gimbal assembly as described in claim 15 wherein a maximum height of said ramp structure with respect to said air bearing surface is less than a minimum fly height of said head with respect to a disk of a disk drive.
